(19) United States
(12) Patent Application Publication
(10) Pub. No.: US 2006/0107582 A1
(43) Pub. Date: May 25, 2006

(54) Fishing lure

(76) Inventors: Harri Leppala, Lahti (FI); Juha Siirtola, Vierumaki (FI)

Correspondence Address: DORITY & MANNING, P.A., POST OFFICE BOX 1449, GREENVILLE, SC, 29602-1449, US

(21) Appl. No.: 10/524,928

(22) PCT Filed: Aug. 20, 2003
(86) PCT No.: PCT/FI03/00614

§ 371 Date: Oct. 17, 2005

(30) Foreign Application Priority Data
Aug. 28, 2002 (FI) 20021537
Dec. 2, 2002 (FI) 20022121

(51) Int. Cl. A01K 85/00

(52) U.S. Cl. 43/42.33; 43/42.47; 43/42.34

(57) ABSTRACT

The present invention concerns a lure comprising a body (1), at least one hook fastener (2), line fastener (6) and, if needed, a swimming plate (4) attached to the body. The body is made as a ready bait body and it is enclosed within a coat (5) manufactured substantially of a transparent material in a die space where the bait body is in.

The present invention concerns a fishing lure, to which special features can be gained by means of a construction thereof in accordance with the invention.

In lures of prior art, the construction generally consists of a body made as one piece or as mirror-image halves joined together, said body corresponding to the final size and shape of the lure. The material of the body is to a great extent optional, traditionally wood, and in newer constructions different plastics suitable for die-casting techniques. Elements needed for the lure like hook fastener, line fastener, swimming plate, are attached to the body.

Patterning and plating are usually made on the surface of the body piece by painting, multicolour printing and protected my means of varnishing. It is also known to use in lures constructions, in which components having influence on the appearance or operation of the lure have been inserted inside the body produced of transparent material. Especially these solutions are used when producing the body from mirror-image halves to be joined together. With this production technique the components in question can be protected against external influences.

Providing appropriate colouring and patterning inside the lure body is, however, from the point of view of the manufacturing technique, essentially more difficult than patterning and colouring of the surface of the lure body. The body halves to be made as mirror images, for example, must be concave in order to achieve an appropriate bait effect by the colouring of the inner surface. Use of printing techniques for colouring this kind of a surface is difficult. Manufacturing technique and constructional strength of the halves demands generally bracings projecting from the surface, which for its part makes the colour treatment of the surface difficult. With a lure made by using this technique the area of the patterned/coloured surface remains smaller than the outer surface of the lure body.

The colouring of the outer surface, for its part, involves problems concerning the durability of the surface. In the use of the lure the surface is influenced by many stresses, demanding great endurance of the colours and protective lacquers to be used on the surface. In practice only materials including problematic solvents can be considered.

An essential improvement of the problems referred to above has been achieved by means of a lure in accordance with the present invention, the characteristics of which become apparent from the enclosed claim 1.

With the present invention the lure body is substantially manufactured to its desired dimensions and shape. Required hook and line fasteners and optionally a swimming plate are attached to the body. With respect to the swimming plate it is also possible to arrange a suitable slot or other attaching facility for the swimming plate, which will not be attached to the body until the finishing phase of the lure. After that, the outer surface of the body will be patterned and coloured by means of some technique known in the art, like painting, printing or by attaching a patterned and coloured film onto the surface. With this patterning and colouring the body will be finished to a ready lure body, in other words with respect to colouring, mainly like a ready lure is supposed to look like.

In the following manufacturing phase, in accordance with the invention, a coat is provided onto the body being prepared, said coat being made of an appropriate transparent or translucence material in a die space, where the body has been inserted. Manufacturing of the coat in this die space is mainly implemented by means of a casting technique, whereby the body acts as a core. A recommended casting method is the die-casting.

Especially suitable material for manufacturing the coat of the lure in accordance with the present invention is silicon rubber. Silicon rubber in this connection stands for a two-component silicone elastomer vulcanizable in a mould. Those are known by name Liquid Silicone Rubber (LSR) and to be acquired on the market from known silicone producers like Bayer and Wacker. Silicone rubbers are well suitable to be used in die-casting techniques because of their chemical characteristics. They have suitable flow characteristics that guarantee especially easy filling of the mould and excellent gas extraction properties. The material penetrates easily for example a channel with a diameter of 0,1 mm. Thus, details of the cast having a shape of a fish, like fins, barbells and other projections can be easily produced. Compared with a lure of prior art, also a prominently thinner coating layer can be used.

Further, there is no need to use even nearly as high pressure in the die-casting process as when using other hot vulcanizable elastomers, where the pressure can be typically 200-300 bar. By using silicone rubbers the pressure can be decreased even to a half of that.

The silicone rubber is typically vulcanizable at a temperature between 150 . . . 200° C. Because there is no need to use a high pressure and a high temperature simultaneously, the materials of the core can be chosen more freely than with a technique of prior art. Also the short in-mould time speeds up the manufacturing process.

The chemical properties of the hardened silicone rubber are excellent in terms of environmental issues because of their inertia Further, the lures in accordance with the present invention are compatible with other fishing tackle produced of silicone. Those can include softeners that are transferred from one object to another in an undesirable way.

The floating properties of silicone rubber are neutral, whereby also the swimming depth of the lure can be exactly adjusted.

Also other thermoplastic materials are usable for implementing the present invention. These are for instance ABS, PMMA, TPU and TPE. Also plastic materials that can be made fluent by means of plasticizers or alternatively plastic materials to be hardened by means of hardeners are usable, as well as the pouring cast technique using those. Especially softeners, however, include components harmful to the environment, whereby the use of this technique is less advisable.

With respect to the coat material to be cast onto the body, also its compatibility with the materials used on the surface of the body must be taken into account, additionally. A significant property of the coat material for implementing a preferred embodiment of the present invention is the bonding of the coat onto the surface material of the body.

An example of a lure in accordance with the present invention is described in enclosed drawings, wherein:

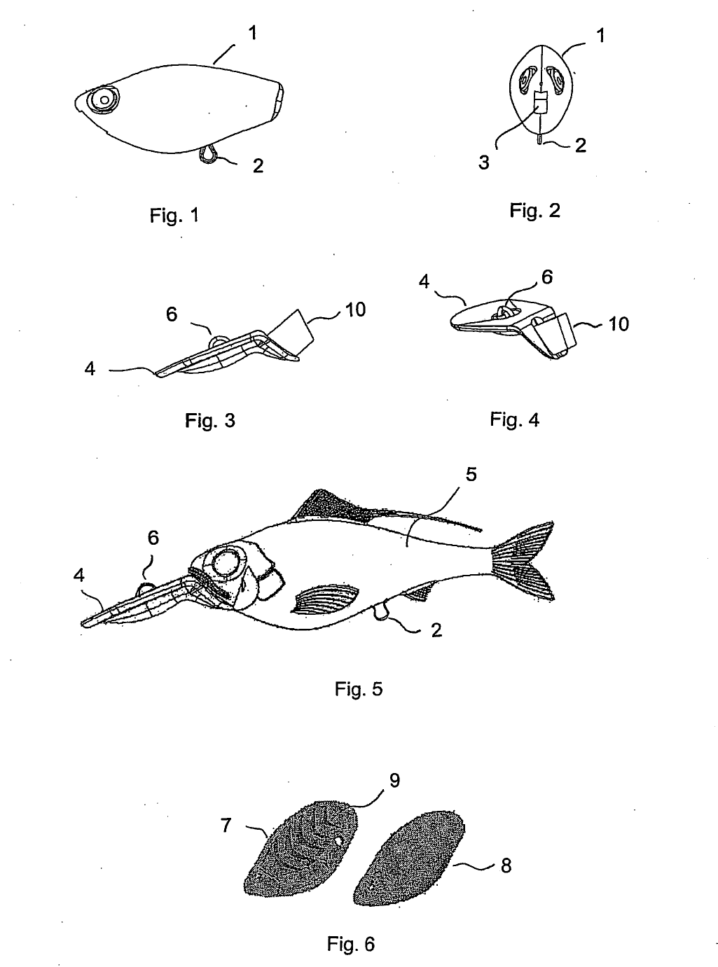

FIG. 1 is a side view of the body of a lure in accordance with the invention,

FIG. 2 is a front view of the body of FIG. 1,

FIG. 3 is a side view of a swimming plate of a lure of the present invention,

FIG. 4 is a perspective view of the element shown in FIG. 3,

FIG. 5 is a side view of a ready-fitted lure with its coat, and

FIG. 6 shows one embodiment of the inner construction of the body.

In the described embodiment, the body 1 of the lure is made into a ready bait body with respect to its outward appearance, external form and its essential equipment. The surface of the body 1 is coloured and patterned according to the desired colouring and patterning of the final lure. Eye 2 has been fastened to the body for attachment of the hook. For the swimming plate 4 (FIGS. 3 and 4) a suitable slot 3 has been formed to the front part of the body (FIG. 2), to receive the projection 10 of the swimming plate. After that the body has been inserted in a die-casting mould, the die space of said die-casting mould being slightly bigger than the body. The body 1 forms thereby the core defining the die space so that required die space is left for the thickness of the desired coat between the core and the mould. The thickness of the coat 5 to be die-cast (FIG. 5) is preferably from 0,5 to 2 mm. With respect to the elements leaving outside the body, like fastening eyes, it must be taken into account that they are adequately left outside the die space.

Also the fastening slot 3 of the swimming plate 4 must be left outside the die space adequately. On the other hand, however, also a mould can be used, that for the part of the fastening slot of the swimming plate 4 has been designed so that suitable fastening elements for attaching the swimming plate to the lure after the die-cast, will be formed of the coat material onto the body slot and/or surface when die-casting the coat. Also a die-casting mould can be used, in which the swimming plate is die-cast in connection with die-casting of the coat. In the described embodiment, the eye 6 for attaching the line is placed onto the swimming plate. This eye could also be attached to the body in the same way as the hook eye 2.

The coat 5 is made of a plastic material classified hard or soft, chosen according to each purpose. With respect to the coat manufacturing it must be taken into account that it can also be made multi-layer, whereby the materials for different layers can have different properties. With materials to be used for different layers, the compatibility of the coat with the body surface can be influenced, like bonding, external properties of the lure and the visual impression of the finished lure. One thing having influence on the visual impression is associated with the refracted index of the material used for the coat. If for instance two layers of hard, clear plastic material have been used for the coat, the refraction of the light at the interface of the layers causes an effect that picks out emphasized the surface pattern and colour of the body.

The visual impression given by the ready lure can be emphasized in a lure in accordance with the invention also by shaping the surface of the body, without having any influence on the swimming properties of the lure by this shaping. Optional embossments and recesses can be formed onto the surface to be levelled off by the coat to be formed onto the surface, and the swimming surface of the lure will be smooth, if desired. Correspondingly, the coat surface can be shaped independently of the body, in case for instance a surface that causes suitable swimming vibrations is desired.

According to the present invention, further, manufacturing of the lure also makes it possible to make the coat so that materials with different properties are used on different parts of the body, for instance different material on the front portion of the lure than on the back portion thereof. The die-cast die must in that case be equipped with two material inlet points arranged in different places and, correspondingly, with separate material handling and feeding devices for both of the inlet points.

The plastic materials in question can generally be classified to belong to the following groups: thermoplastics, cold-cast plastics, mouldable resins, soft glass-clear plastics and vulcanizable materials.

One way to create different colour and light effects in a lure in accordance with the invention is to use inner constructions in the body causing the refraction of light inside the body. This kind of a “lens-effect” can be caused for instance by means of a construction shown in FIG. 6. Body 1 is partly hollow and comprises two halves 7, 8. Ribs 9 give suitable stiffness to the body and, additionally, refract the light so that the lure, when it is ready, gets a tempting appearance. The form and direction of the ribs can be different from those shown in the figure. Also the inner construction of the described body can have different materials, for instance having different refractive indexes, as well as different colouring.

1-11. (canceled)

12. A fishing lure comprising:
a body defining an outer body surface, wherein said body is partly colored substantially as a ready bait body;
a substantially transparent coat, wherein said body is enclosed within said coat and wherein the appearance of said body remains substantially the same with said coat enclosing said body;
at least one hook fastener attached to said body; and
a line fastener attached to said body.

13. The lure of claim 12, further comprising a swimming plate attached to said body.

14. The lure of claim 12, wherein said coat is bonded to said outer body surface of said body.

15. The lure of claim 12, wherein said coat has multiple layers.

16. The lure of claim 15, wherein each said layer of said coat has different refractive indexes than the other layers of said coat.

17. The lure of claim 15, wherein each said layer has a different hardness than the other layers of said coat.

18. The lure of claim 12, wherein said surface of said body is furnished with embossments.

19. The lure of claim 12, wherein said coat influences the swimming properties of the lure.

20. The lure of claim 12, wherein said coat influences the appearance of the lure.

21. The lure of claim 12, wherein said surface defined by said body refracts light.

22. The lure of claim 12, wherein said body is a partly hollow and further defines an inner body surface.

23. The lure of claim 22, wherein said inner body surface of said hollow body defines ribs.

24. The lure of claim 12, wherein said coat comprises silicon rubber.

25. A fishing lure comprising:
a body defining an outer body surface, wherein said body is partly colored substantially as a ready bait body;
a coat substantially manufactured of a transparent material, wherein said ready bait body is enclosed within said coat and wherein the coloring of said body remains substantially the same with said coat enclosing said body;
at least one hook fastener attached to said body;
a swimming plate attached to said body; and
a line fastener attached selectively to either said swimming plate or said body.

26. The lure of claim 25, wherein said coat in bonded to said outer body surface of said body.

27. The lure of claim 25, wherein said coat has multiple layers.

28. The lure of claim 27, wherein each said layer of said coat has different refractive indexes than the other layers of said coat.

29. The lure of claim 27, wherein each said layer has a different hardness than the other layers of said coat.

30. The lure of claim 25, wherein said body is partly hollow.

31. A fishing lure comprising:
a body defining an outer body surface, wherein said body is partly colored substantially as a ready bait body and wherein said bait body is partly hollow so as to further define an inner body surface;
a coat substantially manufactured of a transparent material, wherein said ready body is enclosed within said coat and wherein the coloring of said body remains substantially the same with said coat enclosing said body;
at least one hook fastener attached to said body;
a swimming plate attached to said body; and
a line fastener attached to said swimming plate.
